(19) United States
(12) Patent Application Publication
(10) Pub. No.: US 2007/0058784 A1
(43) Pub. Date: Mar. 15, 2007

(54) RADIOGRAPH-INTERPRETATION SUPPORTING APPARATUS, DATA OUTPUTTING METHOD, DATA INPUTTING METHOD, AND RADIOGRAPH-INTERPRETATION SUPPORTING PROGRAM PRODUCT

(76) Inventors: Akihiro TOSHIMITSU, Otawara-shi (JP); Takashi KONDO, Nasushiobara-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/532,326

(22) Filed: Sep. 15, 2006

(30) Foreign Application Priority Data
Sep. 15, 2005 (JP) 2005-268777

(51) Int. Cl. H05G 1/28; H05G 1/00

(52) U.S. Cl. 378/162; 378/210

(57) ABSTRACT

A radiograph-interpretation supporting apparatus includes an acquisition unit acquiring a data group which includes content data and report data in which link information including first address information for specifying the content data on a first storage device is described, a writing unit writing the content data included in the acquired data group to a second address of a second storage device, and a rewriting unit rewriting the first address information included in the acquired data group to second address information representing the second address.

### CROSS-REFERENCE TO RELATED APPLICATIONS

This application is based upon and claims the benefit of priority from prior Japanese Patent Application No. 2005-268777, filed Sep. 15, 2005, the entire contents of which are incorporated herein by reference.

### BACKGROUND OF THE INVENTION

1. Field of the Invention

The present invention relates to a radiograph-interpretation supporting apparatus that supports radiograph-interpretation by facilitating the handling of an electronic radiograph-interpretation report, to a method of transmitting and receiving radiograph-interpretation report data, and to a radiograph-interpretation supporting program.

2. Description of the Related Art

In medical institutions, a radiologist reads a medical image obtained by a modality, such as an X-ray diagnostic apparatus or an X-ray CT scanner, and makes a radiograph-interpretation report.

The present applicant proposed a technique for supporting such work in JP-A-2005-301453. JP-A-2005-301453 discloses a function of making and referring to a hyperlink report in which, for example, images are associated with letter strings representing an opinion.

Making a hyperlink report includes the following steps, which will be described below in detail.

First, an image formed by a modality is recorded in an image server. The image is transmitted to an image viewer and is displayed on the image viewer. The image is not limited to a radiograph-interpretation object image. Previous radiograph-interpretation reports are also read out from a radiograph-interpretation report server and are then displayed. Information related to patients or medical inspections, such as history information, stored in an image server or a radiograph-interpretation report server may be displayed. Next, a report making screen is displayed by a radiograph-interpretation report client application.

In the radiograph-interpretation report client application, an opinion section is prepared. A doctor or an operator inputs strings representing an opinion for a radiograph-interpretation image in the opinion section. A content is linked to a link object range by moving a cursor to a string to be linked among the input strings so as to specify a link object range, by dragging any content to be linked among contents, such as a content among displayed images, previous medical reports, and history information, and by dropping the dragged content onto the link object range. Hyperlink information on the content linked to a string, which is within a link object range, is added to radiograph-interpretation report data representing a radiograph-interpretation report. The hyperlink information includes address information and content identification information. The address information specifies, for example, a server storing the corresponding content, and the content identification information is uniquely assigned to the corresponding content. When the content is an image, the hyperlink information may include parameters necessary for displaying the content.

In the hyperlink report made as described above, the color of a hyperlinked link object range, that is, string is changed, and the hyperlinked link object range, that is, string is underlined such that the corresponding string is recognizably displayed. In response to the linking of the link object range, that is, string, the content linked to the link object range is acquired from, for example, an image server on the basis of the hyperlink information and is displayed. Therefore, it is possible to show the content of the radiograph-interpretation report by a simple operation in an exact and easily understood manner.

A patient who took a medical examination in a first hospital may take a medical examination or undergo medical treatment for the same disease in a second hospital with an introduction from the first hospital. In this case, it may be necessary for the second hospital to refer to a radiograph-interpretation report made in the first hospital. If a condition that a computer or a server in the second hospital can access, for example, a server in the first hospital is not satisfied, it is difficult that the second hospital directly refers to the radiograph-interpretation report.

However, it is possible to refer to individual data items by copying radiograph-interpretation report data or content data onto, for example, a portable medium, and by reading the copied data through, for example, an image viewer or a radiograph-interpretation report client of the second hospital.

However, when the storage of the content data is changed, it is difficult to specify the content data on the basis of hyperlink information. As a result, it is difficult to exactly show the hyperlink report.

### BRIEF SUMMARY OF THE INVENTION

Accordingly, it is an object of the present invention to provide a radiograph-interpretation supporting apparatus, a data outputting method, a data inputting method, and a radiograph-interpretation supporting program product which makes it possible to exactly show a hyperlink report even when the storage of content data is changed.

According to a first aspect of the invention, a radiograph-interpretation supporting apparatus includes: an acquisition unit acquiring a data group which includes content data and report data in which link information including first address information for specifying the content data on a first storage device is described; a writing unit writing the content data included in the acquired data group to a second address of a second storage device; and a rewriting unit rewriting the first address information included in the acquired data group to second address information representing the second address.

According to a second aspect of the invention, a radiograph-interpretation supporting apparatus includes: a first storage device storing content data in a first address; a report storage device storing report data in which link information including first address information representing the first address is described; a reading unit reading the report data from the report storage device in order to output the report data, and reading the content data from the first storage device on the basis of the link information included in the report data; and an output unit outputting a data group including the read report data and the read content data.

According to a third aspect of the invention, a data inputting method of a radiograph-interpretation supporting apparatus includes the steps of: acquiring data group including content data and report data in which link data including first address information specifying the content data on the first storage device is described; writing the content data included in the acquired data group to a second address of a second storage device; and rewriting the first address information included in the acquired data group to second address information representing the second address.

According to a fourth aspect of the invention, there is provided a data outputting method of a radiograph-interpretation supporting apparatus which includes a first storage device storing content data in a first address and a report storage device storing report data in which link information including first address information representing the first address is described. The method includes the steps of: reading the report data from the report storage device in order to output the report data, and reading the content data from the first storage device on the basis of the link information included in the corresponding report data; and outputting a data group including the read report data and the read content data.

According to a fifth aspect of the invention, there is provided a radiograph-interpretation supporting program product which allows a computer to function as: an acquisition unit acquiring a data group including content data and report data in which link information including first address information for specifying the content data on a first storage device is described; a writing unit writing the content data included in the acquired data group to a second address of a second storage unit; and a rewriting unit rewriting the first address information included in the acquired data group to second information representing the second address.

According to a sixth aspect of the invention, there is provided a radiograph-interpretation supporting program product which allows a computer which includes a first storage device storing content data in a first address and a report storage device storing report data in which link data including first address information representing the first address is described to function as: a reading unit reading the report data from the report storage device in order to output the report data, and reading the content data from the first storage device on the basis of the link information included in the report data; and an output unit outputting a data group including the read report data and the read content data.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram illustrating the configuration of a radiograph-interpretation supporting system according to an embodiment of the invention;

FIG. 2 is a view showing the relationship among functions that a processor executes by performing a process on the basis of a radiograph-interpretation supporting program shown in FIG. 1;

FIG. 3 is a flow chart showing a procedure performed by a processor of the radiograph-interpretation supporting system shown in FIG. 2;

FIG. 4 is a flow chart showing a procedure performed by the processor of the radiograph-interpretation supporting system shown in FIG. 2;

FIG. 5 is a view showing an example of corresponding information; and

FIGS. 6A to 6C are views showing an aspect of the structure of hyperlink information and the rewriting of address information.

### DETAILED DESCRIPTION OF THE INVENTION

Hereinafter, an embodiment of the invention will be described with reference to the accompanying drawings.

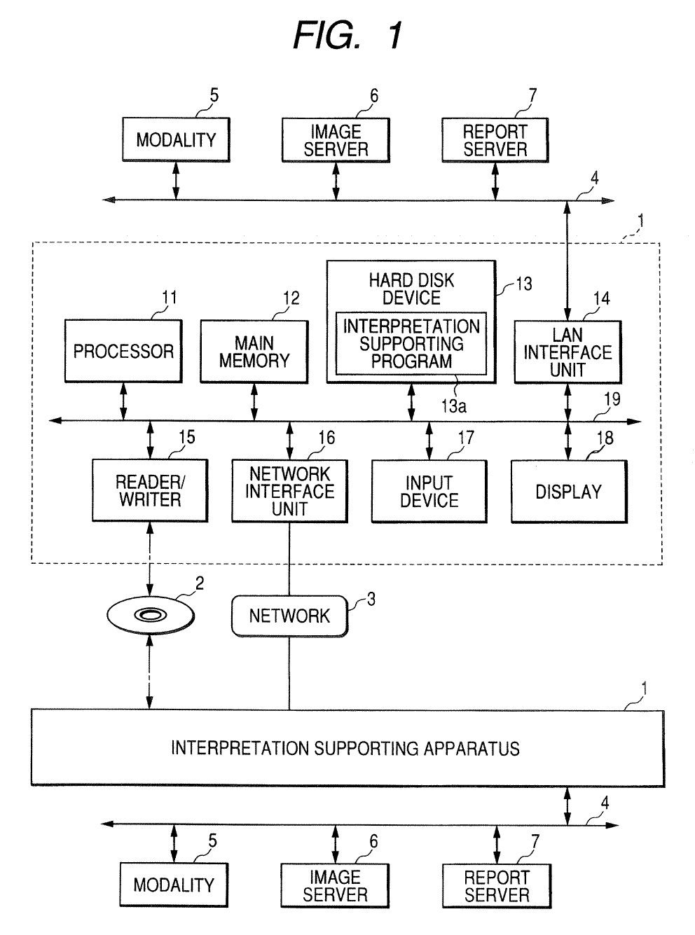

FIG. 1 is a block diagram showing the configuration of a radiograph-interpretation supporting system according to the embodiment of the invention.

The radiograph-interpretation supporting system enables a data group including radiograph-interpretation report data representing a hyperlink report and image data linked to the hyperlink report data to be transmitted between two radiograph-interpretation supporting apparatuses 1 through a portable medium 2 or a network 3. Typically, the two radiograph-interpretation supporting apparatuses 1 are installed in different hospitals. However, the installation mode may be arbitrary. The two radiograph-interpretation supporting apparatuses 1 are connected to LANs (local area networks) 4 built in the respective hospitals. In each hospital, a modality 5, an image server 6, and a report server 7 are installed. A plurality of modalities 5, a plurality of image servers 6, and a plurality of report servers 7 may be installed in each hospital. The modalities 5, the image servers 6, and the report servers 7 are also connected to the LAN 4 in each hospital. The LANs 4 of the two hospitals are separated from each other.

The modality 5 is, for example, an X-ray diagnostic apparatus or an X-ray CT scanner and generates image data representing a medical image. The image server 6 has a storage medium such as a hard disk for storing image data. The report server 7 has a storage medium such as a hard disk for storing radiograph-interpretation report data.

The radiograph-interpretation supporting apparatus 1 includes a processor 11, a main memory 12, a hard disk device 13, a LAN interface unit 14, a reader/writer 15, a network interface unit 16, an input device 17, and a display 18. These components are connected to one another through buses 19.

The processor 11 performs various control processes by executing a software process according to programs stored in the hard disk device 13.

The main memory 12 temporarily stores software that is extracted from the hard disk device 13 and will be actually used in the processor 11. Further, the main memory 12 is used as a work area of the processor 11.

The hard disk device 13 stores an OS (operating system) program used by the processor 11. The hard disk device 13 also stores various programs and other data. Data stored in the hard disk device 13 includes a radiograph-interpretation supporting program 13a.

The LAN interface unit 14 is connected to the LAN 4. The LAN interface unit 14 performs the transmission and reception of data through the LAN 4.

The reader/writer 15 reads out data stored in the portable medium 2. The reader/writer 15 writes data to the portable medium 2.

The network interface unit 16 is connected to the network 3. The network interface unit 16 performs communication through the network 3.

The input device 17 receives various instructions input by an operator. The input device 17 may be a known device, such as a keyboard, a mouse, or a touch panel.

The display 18 performs image display for showing a variety of information to the operator.

A general-purpose computer may be used as the radiograph-interpretation supporting apparatus 1. In this case, the radiograph-interpretation supporting program 13a is not initially installed, but is supplied as an application program. As a part of the introduction work of the radiograph-interpretation supporting apparatus 1, the radiograph-interpretation supporting program 13a stored in a removable storage medium, such as a CD-ROM, is installed in the hard disk device 13. Alternatively, the radiograph-interpretation supporting program 13a downloaded through the network 3 may be installed.

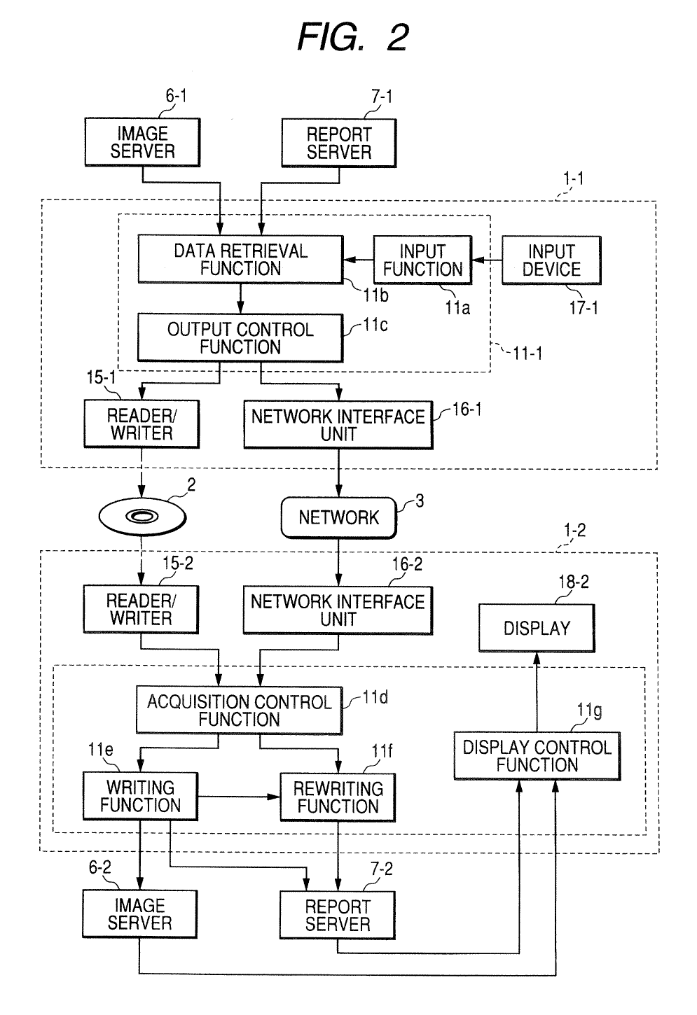

The processor 11 operates as a radiograph-interpretation report client for making a hyperlink report by performing a process on the basis of the radiograph-interpretation supporting program 13a. The function of the processor 11 as the radiograph-interpretation report client can adopt, for example, a function disclosed in JP-A-2005-301453. Besides, the radiograph-interpretation supporting program 13a allows the processor 11 to execute the following functions, as shown in FIG. 2: an input function 11a; a data retrieval function 11b; an output control function 11c; an acquisition control function 11d; a writing function 11e; a rewriting function 11f; and a display control function 11g. A part or all of these functions may be realized by hardware, such as logic circuits. Alternatively, the above-mentioned functions may be realized by combining hardware and software control.

The input function 11a, the data retrieval function 11b, and the output control function 11c are available in the radiograph-interpretation supporting apparatus 1 which transmits a data group. The writing function 11e, the rewriting function 11f, and the display control function 11g are available in the other radiograph-interpretation supporting apparatus 1 which receives a data group. Hereinafter, for easy explanation, when it is necessary to divide the radiograph-interpretation supporting apparatuses into a transmission side and a reception side, as shown in FIG. 2, the one on the transmission side and the one on the reception side are referred to as a radiograph-interpretation supporting apparatus 1-1 and a radiograph-interpretation supporting apparatus 1-2, respectively. Further, as shown in FIG. 2, individual components included in the radiograph-interpretation supporting apparatus 1-1 and individual apparatuses installed in the same hospital as the radiograph-interpretation supporting apparatus 1-1 are denoted by reference numerals formed by adding ‘-1’ to the end of the reference numerals shown in FIG. 1. Similarly, as shown in FIG. 2, individual components included in the radiograph-interpretation supporting apparatus 1-2 and individual apparatuses installed in the same hospital as the radiograph-interpretation supporting apparatus 1-2 are denoted by reference numerals formed by adding ‘-2’ to the end of the reference numerals shown in FIG. 1.

The input function lla is used to assign a radiograph-interpretation report to be output (hereinafter, referred to as an output report) in order to be transmitted to the radiograph-interpretation supporting apparatus 1-2 or to assign a restricted amount of image data to be output. The data retrieval function 11b is used to retrieve data to be included in a data group from the image server 6-1 and the report server 7-1 according to instruction input by the input function 11a and to read out the corresponding data. The output control function lic is used to transmit the data group to the reader/writer 15-1 or the network interface unit 16-1 according to the output mode.

The acquisition control function lid acquires the data group to be transmitted through the portable medium 2 or the network 3 through the reader/writer 15-2 or the network interface unit 16-2. The writing function 11e writes the data included in the data group acquired by the acquisition control function lid to the image server 6-2 or the report server 7-2. The rewriting function 11f rewrites hyperlink information included in the radiograph-interpretation report written to the report server 7-2. The display control function 11g controls the display 18-2 to display a hyperlink report on the basis of the data stored in the image server 6-2 and the report server 7-2.

Next, the operation of the radiograph-interpretation supporting system having the above-mentioned configuration will be described.

In the radiograph-interpretation supporting system, when a hyperlink report is made in the first hospital, radiograph-interpretation report data representing the hyperlink report is stored in the report server 7 installed in the first hospital. Image data linked to the hyperlink report is image data stored in the image server 6 installed in the first hospital.

When the hyperlink report managed in the first hospital as described above is transmitted to the radiograph-interpretation supporting apparatus installed in the second hospital, the radiograph-interpretation supporting apparatus 1 installed in the first hospital becomes the reception-side radiograph-interpretation supporting apparatus 1-1, and the radiograph-interpretation supporting apparatus 1 installed in the second hospital becomes the transmission-side radiograph-interpretation supporting apparatus 1-2. In this case, the transmission and reception of a data group necessary for showing the hyperlink report are performed as follows.

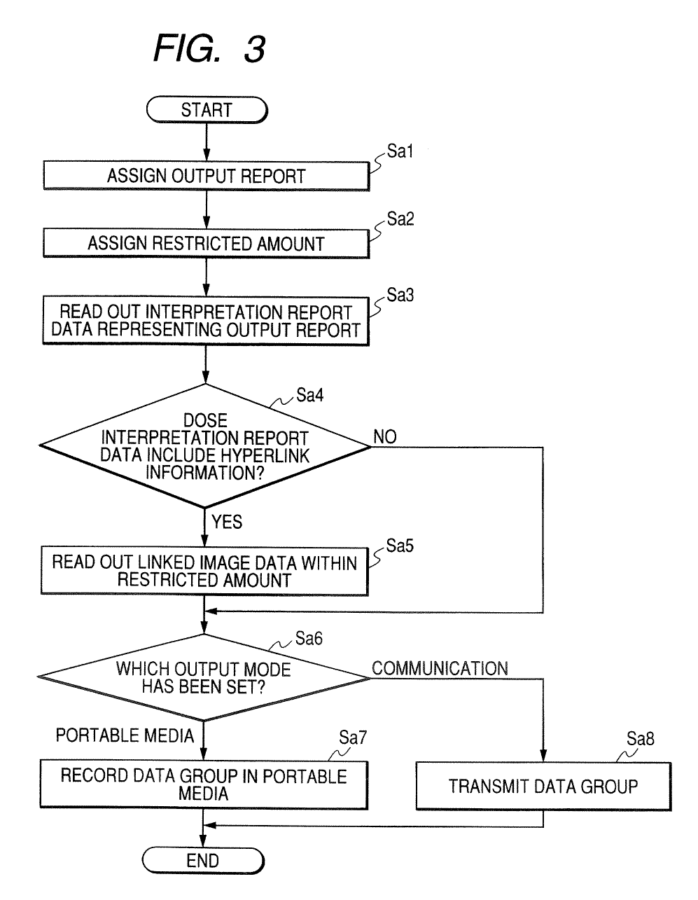

FIG. 3 is a flow chart illustrating the procedure of the processor 11-1 of the radiograph-interpretation supporting apparatus 1-1.

In Step Sa1, the processor 11-1 assigns an output report by the input function 11a. In Step Sa2, the processor 11-1 assigns a restricted amount of data by the input function 11a. The restricted amount is assigned as, for example, the number of link hierarchies.

In Step Sa3, the processor 11-1 retrieves radiograph-interpretation report data representing the output report from the report server 7-1 and reads out the corresponding data by the data retrieval function 11b.

In Step Sa4, the processor 11-1 determines whether the read radiograph-interpretation report data includes hyperlink information or not by the data retrieval function 11b. When the read radiograph-interpretation report data includes hyperlink information, the processor 11-1 proceeds from Step Sa4 to Step Sa5. When the read radiograph-interpretation report data does not include hyperlink information, the processor 11-1 bypasses Step Sa5 and proceeds to Step Sa6.

In Step Sa5, the processor 11-1 reads out image data linked by the hyperlink information included in the radiograph-interpretation report data by the data retrieval function 11b with the restricted amount as an upper limit.

In Step Sa6, the processor 11-1 confirms the output mode by the output control function 11c. If the output mode has already been set to a portable media mode or if the operator sets the output mode to the portable media mode, the processor 11-1 proceeds from Step Sa6 to Step Sa7.

In Step Sa7, the processor 11-1 records a data group including the radiograph-interpretation report data obtained in Step Sa3 and the image data obtained in Step SaS on the portable medium 2 through the reader/writer 15-1 by the output control function 11c. When the recoding is completed, the processor 11-1 finishes the process shown in FIG. 3.

Meanwhile, if the output mode has already been set to a communication mode or if the operator sets the output mode to the communication mode, the processor 11-1 proceeds from Step Sa6 to Step Sa8.

In Step Sa8, the processor 11-1 transmits the data group including the radiograph-interpretation report data obtained in Step Sa3 and the image data obtained in Step Sa5 to the radiograph-interpretation supporting apparatus 1-2 through the network 3 by the output control function 11c.

The processor 11-1 may add, to the data group, management information of the radiograph-interpretation report data of the hospital where the radiograph-interpretation supporting apparatus 1-1 is installed. The management information may include, for example, identification information of the facility having the radiograph-interpretation supporting apparatus 1-1 installed therein, identification information on patients in the corresponding facility, and identification information on attending physicians. Further, the processor 11-1 may perform a protecting process on the data group for allowing only the authorized readers to read the content of the data group. In order to perform the protecting process, for example, a known encryption technique can be used. An object subjected to the protecting process may be the whole data group or a portion of the data group.

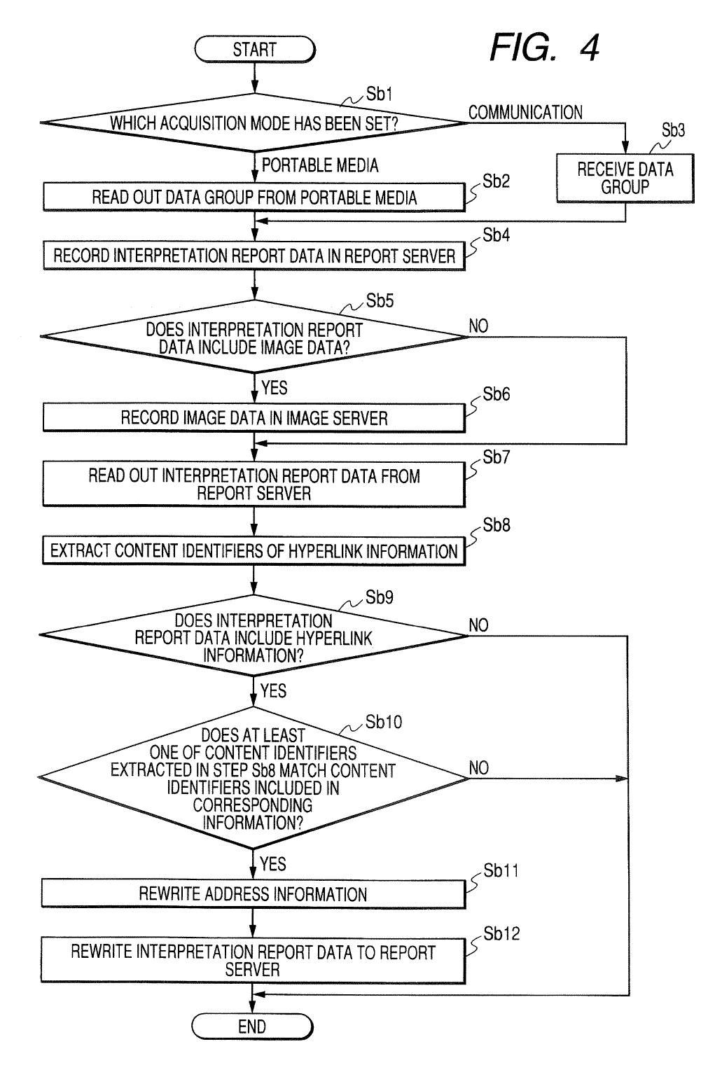

FIG. 4 is a flow chart illustrating the procedure of the processor 11-2 of the radiograph-interpretation supporting apparatus 1-2.

In Step Sb1, the processor 11-2 confirms an acquisition mode by the acquisition control function 11d. If the acquisition mode has already been set to the portable media mode, or if the operator sets the acquisition mode to the portable media mode, the processor 11-2 proceeds from Step Sb1 to Step Sb2.

In Step Sb2, the processor 11-2 reads out the data group stored in the portable medium 2 using the reader/writer 15-2 by the acquisition control function 11d. Subsequently, the processor 11-2 proceeds to Step Sb4.

Meanwhile, if the acquisition mode has already been set to the communication mode or if the operator sets the acquisition mode to the communication mode, the processor 11-2 proceeds from Step Sb1 to Step Sb3.

In Step Sb3, the processor 11-2 receives the data group transmitted through the network 3 by using the network interface unit 16-2 by the acquisition control function 11d.

In Step Sb4, the processor 11-2 writes the radiograph-interpretation report data of the data group acquired in Step Sb2 or Step Sb3 to the report server 7-2 by the writing function 11e. When writing the acquired radiograph-interpretation report data, the processor 11-2 may write management information of the radiograph-interpretation report data of a facility having the radiograph-interpretation supporting apparatus 1-2 installed therein to the report server 7-2. The management information may include, for example, identification information of the facility having the radiograph-interpretation supporting apparatus 1-2 installed therein, identification information on patients in the corresponding facility, and identification information on attending physicians. When the data group acquired in Step Sb2 or Step Sb3 includes the management information of the radiograph-interpretation supporting apparatus 1-1, the processor 11-2 may write the management information of the radiograph-interpretation supporting apparatus 1-1 as management information of the transmission-side facility to the report server 7-2 to be separated from the management information of the reception-side facility. When the protecting process has been performed on the radiograph-interpretation report data, the processor 11-2 may cancel the protection of the radiograph-interpretation report data and then write the radiograph-interpretation report data to the report server 7-2.

Further, the processor 11-2 may transmit the management information of the reception-side facility to a patient management system of the facility having the radiograph-interpretation supporting apparatus 2-1 installed therein. In this case, the patient management system adds the transmission-side management information to the patient management information of the reception-side facility as, for example, management information on an introducing facility to manage.

In Step Sb5, the processor 11-2 determines whether the data group acquired in Step Sb2 or Step Sb3 includes image data by the writing function 11e. When the data group includes image data, the processor 11-2 proceeds from Step Sb5 to Step Sb6. When the data group does not include image data, the processor 11-2 bypasses Step Sb6 and proceeds to Step Sb7.

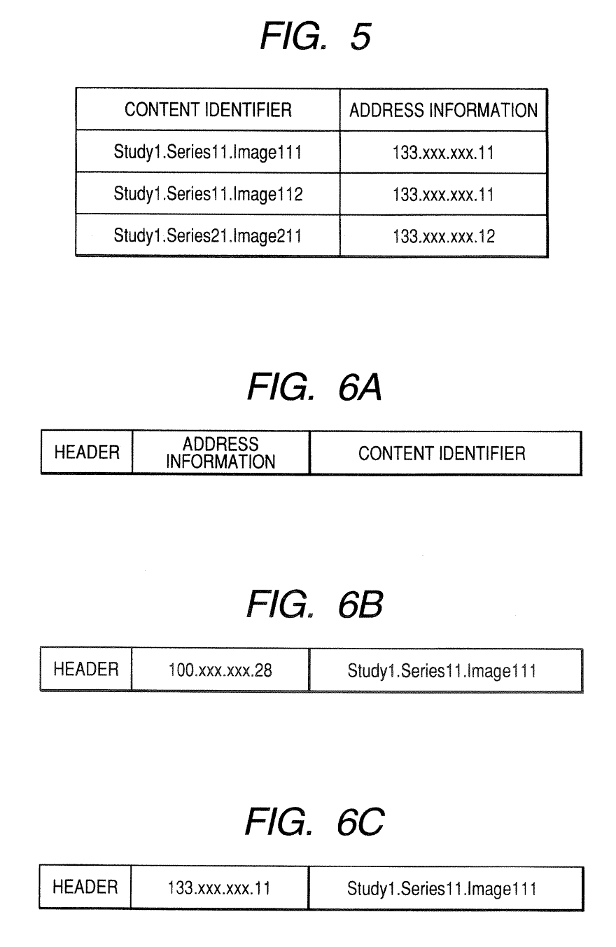

In Step Sb6, the processor 11-2 writes the image data included in the data group to the image server 6-2 by the writing function 11e. When there are a plurality of image servers 6-2, the processor 11-2 writes the image data to any one of the plurality of image servers 6-2. The processor 11-2 may determine to which image server 6-2 the image data is written according to, for example, a predetermined rule. When one data group includes a plurality of image data, the processor 11-2 may write the respective image data to a plurality of different image servers 6-2. The processor 11-2 creates corresponding information reflecting the result of the writing of the image data, as shown in FIG. 5, by the writing function 11e. The corresponding information represents the relationship between content identifiers of the image data and address information of the image servers having the image data written thereto. The content identifiers are assigned to individual image data. The content identifier is information including InstanceUID of a DICOM (digital imaging and communication in medicine) standard and thus is unique. When the protecting process has been performed on the image data, the processor 11-2 may cancel the protection of the image data and then write the image data to the image server 6-2.

In Step Sb7, the processor 11-2 reads out the radiograph-interpretation report data stored in Step Sb4 from the report server 7-2 by the rewriting function 11f.

In Step Sb8, the processor 11-2 extracts content identifiers from hyperlink information included in the read radiograph-interpretation report data by the rewriting function 11f.

In Step Sb9, the processor 11-2 determines whether the radiograph-interpretation report data includes hyperlink information or not by the rewriting function 11f. When the radiograph-interpretation report data includes hyperlink information, the processor 11-2 proceeds from Step Sb9 to Step Sb10. When the radiograph-interpretation report data does not include hyperlink information, the processor 11-2 bypasses all the subsequent processes and finishes the process shown in FIG. 4.

In Step Sb10, the processor 11-2 determines whether at least one of the individual content identifiers extracted in Step Sb8 matches the content identifiers included in the corresponding information. When at least one of the individual content identifiers extracted in Step Sb8 matches the content identifiers included in the corresponding information, the processor 11-2 proceeds from Step Sb10 to Step Sb11. When no individual content identifiers extracted in Step Sb8 match the content identifiers included in the corresponding information, the processor 11-2 bypasses all the subsequent processes and finishes the process shown in FIG. 4.

In Step Sb11, the processor 11-2 rewrites the address information of the hyperlink information including the content identifiers matched with any of the content identifiers included in the corresponding information to address information related to the corresponding content identifiers in the corresponding information, by the rewriting function 11f.

More specifically, the hyperlink information has, for example, a format shown in FIG. 6A. When the hyperlink information included in the radiograph-interpretation report data read in Step Sb7 has the content shown in FIG. 6B and the corresponding information created in Step Sb6 has the content shown in FIG. 5, a content identifier matched with the content identifier shown in FIG. 6B exists in the corresponding information. Then, the processor 11-2 rewrites original address information ‘100.xxx.xxx.28’ to address information ‘133.xxx.xxx.11’ related to the content identifier ‘Study1.Series11.Image111’ in the corresponding information, as shown in FIG. 6C.

In Step Sb12, the processor 11-2 overwrites the radiograph-interpretation report data read in Step Sb7 with radiograph-interpretation report data having the rewritten address information by the rewriting function 11f. When the overwriting is completed, the processor 11-2 finishes the process shown in FIG. 4.

When the display of the hyperlink report is performed, the processor 11-2 controls the display 18-2 on the basis of the radiograph-interpretation report data having the rewritten address information by the display control function 11g.

According to this embodiment, in the reception side, the radiograph-interpretation report data stored in the report server 7-2 includes hyperlink information with address information for defining the image server 7-2. Therefore, it is possible to exactly acquire the image data linked to the hyperlink report and thus to appropriately show the hyperlink report in the radiograph-interpretation supporting apparatus 1-2.

Further, according to this embodiment, in the transmission side, since image data is output by using the restricted amount assigned by the operator as an upper limit, it is possible to solve the shortage of the capacity of the reception-side image server 6.

As described above, when the data group includes the management information of the transmission-side facility and is held in the reception-side facility together with the radiograph-interpretation report data, it is effective in further performing communication between the transmission-side facility and the reception-side facility. For example, when a doctor of the reception-side facility wants to inquire about the radiograph-interpretation report to the transmission-side facility, he can easily see the destination of the inquiry by referring to the management information. Then, when referring to patients of the reception side and the transmission side by using the patient management information of the transmission-side facility shown in the management information, the reception-side doctor can correctly specify the same patient between both sides and thus can smoothly make inquiries.

Further, as described above, when a patient management system of the reception-side facility adds the transmission-side management information to the patient management information of the reception-side and holds the management information of both sides, it is possible to include the management information of the transmission-side facility in information returned from the reception-side facility to the transmission-side facility. For example, when a second radiograph-interpretation report on the same patient as a first radiograph-interpretation report supplied from a facility A to a facility B is made in the facility B, it is possible to include management information of the facility A in the second radiograph-interpretation report.

Furthermore, as described above, when the protecting process is performed on the whole data group or a part of the data group, it is possible to prevent a third party from reading the radiograph-interpretation report.

This embodiment can be variously modified as follows.

The embodiment can correspond to a case in which content data other than image data is linked to a hyperlink report by processing the content data by the same method as that in which the image data is processed.

When only one image server 6-2 exists, the creating of the corresponding information may be omitted. In this case, it is only necessary to rewrite to the image server 6-2 the address information of the hyperlink information, including the content identifiers, of the image data written to the image server 6-2.

When the radiograph-interpretation supporting apparatus 1 is a reception-side apparatus, Steps Sb4 and Sb7 shown in FIG. 4 may be omitted by storing the acquired radiograph-interpretation report data in, for example, the main memory 12 or the hard disk device 13, rewriting address information of the stored radiograph-interpretation report data, and writing the rewritten address information to the report server 7.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A radiograph-interpretation supporting apparatus comprising:
an acquisition unit acquiring a data group which includes content data and report data in which link information including first address information for specifying the content data on a first storage device is described;
a writing unit writing the content data included in the acquired data group to a second address of a second storage device; and
a rewriting unit rewriting the first address information included in the acquired data group to second address information representing the second address.

2. The radiograph-interpretation supporting apparatus according to claim 1,
wherein the data group includes a plurality of content data, and
unique identification information items are included in the plurality of content data.

3. The radiograph-interpretation supporting apparatus according to claim 2,
wherein the writing unit creates corresponding information representing the correspondence between a plurality of second address information items representing a plurality of second addresses to which the plurality of content data has been written and the identification information items included in the plurality of content data, and
the rewriting unit rewrites a plurality of first address information items included in the acquired data group to the plurality of second address information items on the basis of the corresponding information.

4. The radiograph-interpretation supporting apparatus according to claim 1,
wherein the acquisition unit acquires the data group from a portable storage medium.

5. The radiograph-interpretation supporting apparatus according to claim 1,
wherein the acquisition unit acquires the data group through communication lines.

6. The radiograph-interpretation supporting apparatus according to claim 1, further comprising:
a report showing unit showing a report on the basis of the report data with the address information rewritten by the rewriting unit.

7. The radiograph-interpretation supporting apparatus according to claim 1, wherein, when the data group includes management information of the report data of a facility which outputs the acquired data group, the writing unit writes the management information to the second storage device or a separate storage device.

8. The radiograph-interpretation supporting apparatus according to claim 1, further comprising:
a protection canceling unit canceling a protection process when the protection process is performed on a part of or the whole data group in order to restrict the viewing thereof.

9. A radiograph-interpretation supporting apparatus comprising:
a first storage device storing content data in a first address;
a report storage device storing report data in which link information including first address information representing the first address is described;
a reading unit reading the report data from the report storage device in order to output the report data, and reading the content data from the first storage device on the basis of the link information included in the report data; and
an output unit outputting a data group including the read report data and the read content data.

10. The radiograph-interpretation supporting apparatus according to claim 9,
wherein the output unit writes the data group to a portable storage medium.

11. The radiograph-interpretation supporting apparatus according to claim 9,
wherein the output unit outputs the data group through communication lines.

12. The radiograph-interpretation supporting apparatus according to claim 9, further comprising:
an input unit inputting assignment of a restricted amount of content data to be output,
wherein the output unit outputs the content data represented by the link information described in the report data within a range of the restricted amount.

13. The radiograph-interpretation supporting apparatus according to claim 12,
wherein the input unit inputs the restricted amount as the number of link hierarchies.

14. The radiograph-interpretation supporting apparatus according to claim 9,
wherein the output unit includes management information of the report data of a facility using the radiograph-interpretation supporting apparatus in the data group and then outputs the data group.

15. The radiograph-interpretation supporting apparatus according to claim 9, further comprising:
a unit performing a protecting process on a part of or the whole data group in order to restrict the viewing thereof.

16. A data inputting method comprising the steps of:
acquiring data group including content data and report data in which link data including first address information for specifying the content data on a first storage device is described;
writing the content data included in the acquired data group to a second address of a second storage device; and
rewriting the first address information included in the acquired data group to second address information representing the second address.

17. A data outputting method of a radiograph-interpretation supporting apparatus which includes a first storage device storing content data in a first address and a report storage device storing report data in which link information including first address information representing the first address is described, the method comprising the steps of:
reading the report data from the report storage device in order to output the report data and, reading the content data from the first storage device on the basis of the link information included in the corresponding report data; and
outputting a data group including the read report data and the read content data.

18. A radiograph-interpretation supporting program product allowing a computer to function as:
an acquisition unit acquiring a data group including content data and report data in which link information including first address information for specifying the content data on a first storage device is described;
a writing unit writing the content data included in the acquired data group to a second address of a second storage unit; and
a rewriting unit rewriting the first address information included in the acquired data group to second information representing the second address.

19. A radiograph-interpretation supporting program product allowing a computer which includes a first storage device storing content data in a first address and a report storage device storing report data in which link data including first address information representing the first address is described to function as:
a reading unit reading the report data from the report storage device in order to output the read data, and reading the content data from the first storage device on the basis of the link information included in the report data; and
an output unit outputting a data group including the read report data and the read content data.
